(19) United States
(12) Patent Application Publication
(10) Pub. No.: US 2006/0163472 A1
(43) Pub. Date: Jul. 27, 2006

(54) Correcting phases for ion polarity in ion trap mass spectrometry

(75) Inventor: Edward G. Marquette, Oakland, CA (US)

Correspondence Address: Varian Inc.;Legal Department, 3120 Hansen Way D-102, Palo Alto, CA, 94304, US

(73) Assignee: Varian, Inc.

(21) Appl. No.: 11/199,674

(22) Filed: Aug. 8, 2005

Related U.S. Application Data
(60) Provisional application No. 60/646,767, filed on Jan. 25, 2005.

(51) Int. Cl. B01D 59/44

(52) U.S. Cl. 250/290

(57) ABSTRACT

In a method and apparatus for adjusting a composite electric field to be applied to an ion trap to accommodate switching the operation of the ion trap between a positive ion mode and a negative ion mode, the composite electric field includes a plurality of component fields including at least one AC trapping field and one or more supplemental AC fields. A phase of one or more of the component fields is adjusted such that a force imparted by the composite field to a negative ion in the ion trap will be substantially the same as the force imparted by the composite field to a positive ion in the ion trap.

### CROSS-REFERENCE TO RELATED APPLICATION

This application claims the benefits of U.S. Provisional Patent Application Ser. No. 60/646,767, titled “METHOD OF CORRECTING PHASES FOR ION POLARITY IN A MASS SPECTROMETER,” filed Jan. 25, 2005.

### FIELD OF THE INVENTION

The present invention relates generally to ion trap apparatus and methods for their operation. More particularly, the present invention relates to ion trap apparatus of the type that provide a composite electric field for trapping and ejecting ions, and methods for adjusting the field to accommodate switching between a positive ion mode of operation and a negative ion mode of operation.

### BACKGROUND OF THE INVENTION

Ion traps have been employed in a number of different applications in which control over the motions of ions is desired. In particular, ion traps have been utilized as mass analyzers or sorters in mass spectrometry (MS) systems. The ion trap of an ion trap-based mass analyzer may be formed by electric and/or magnetic fields. The present disclosure is primarily directed to ion traps formed solely by electric fields without magnetic fields. However, the subject matter disclosed and claimed herein may also find application to ion traps that operate based on ion cyclotron resonance (ICR) techniques, which employ a magnetic field to trap ions and an electric field to eject ions from the trap (or ion cyclotron cell).

Insofar as the present disclosure is concerned, MS systems are generally known and need not be described in detail herein. Briefly, a typical MS system includes a sample inlet system, an ionization device, a mass analyzer, an ion detector, a signal processor, and readout/display means. Additionally, the modern MS system typically includes a computer or other type of electronic controlling and processing means for controlling the functions of one or more components of the MS system, storing information produced by the MS system, providing libraries of molecular data useful for analysis, and the like. The MS system also includes a vacuum system to enclose the mass analyzer in a controlled, evacuated environment. Depending on design, all or part of the sample inlet system, ionization device and ion detector may also be enclosed in the evacuated environment.

In operation, the sample inlet system introduces a small amount of sample material to the ionization device, which may be integrated with the sample inlet system depending on design. The ionization device converts components of the sample material into a gaseous stream of positive or negative ions. The ions are then introduced into the mass analyzer. Alternatively, and particularly when the mass analyzer includes an ion trap, the sample inlet system may introduce sample material directly into the mass analyzer. In this alternative case, the ionization source conducts a means of ionization such as an energy beam into the mass analyzer, and ions are then formed in the mass analyzer.

The mass analyzer separates the ions according to their respective mass-to-charge ratios. The term “mass-to-charge” is often expressed as m/z, m/e, or m/q, or simply “mass” given that the charge z or e often has a value of 1. Accordingly, for purposes of the present disclosure, terms such as “m/z ratio” and “mass” are treated equivalently. The mass analyzer produces a flux of ions resolved according to m/z ratio that is collected at the ion detector. The ion detector functions as a transducer, converting the mass-discriminated ionic information into electrical signals suitable for processing/conditioning by the signal processor, storage in memory, and presentation by the readout/display means. A typical output of the readout/display means is a mass spectrum, such as a series of peaks indicative of the relative abundances of ions at detected m/z values, from which a trained analyst can obtain information regarding the sample material processed by the MS system.

Many ion traps have a quadrupolar electrode configuration. The quadrupole structure may be three-dimensional or two-dimensional. The geometry of a three-dimensional quadrupole ion trap is typically envisioned in terms of a z-axis and a radial r-axis orthogonal to the z-axis. The three-dimensional electrode structure is rotationally symmetrical about the z-axis. This type of ion trap includes a ring-shaped electrode (or simply “ring” electrode) swept about the z-axis, a top end cap electrode positioned above the ring electrode, and a bottom end cap electrode positioned below the ring electrode in opposition to the top end cap electrode. The three-dimensional electrode structure defines an interior space generally defined by the spacing between the top end cap electrode and bottom end cap electrode along the z-axis and the radial distance of the ring electrode from the center point of the interior space along the r-axis. The ring electrode and end cap electrodes are typically formed by hyperboloids of revolution about the z-axis or, at least, the surfaces of the electrodes facing the interior space are shaped as hyperbolas.

In operation, an ion trapping volume or region is formed in the interior space in which ions of selected mass(es) or mass range(s) may be stably trapped and from which selected ions may be ejected for detection and mass analysis. An alternating (AC) voltage of radio frequency (RF) is typically applied to the ring electrode to create a potential difference between the ring electrode and the end cap electrodes. This AC potential forms a three-dimensional, quadrupolar, electric trapping field that imparts a three-dimensional, time-dependent restoring force directed towards the center of the electrode assembly. The parameters of the waveform of AC potential may be varied such that the trapping field is electrodynamic. Ions are confined within the trapping field when their trajectories are bounded in both the r- and z-directions. Whether an ion is trapped in a stable manner depends on several parameters, often termed trapping, scanning, or Mathieu parameters, which include the m/z ratio (or, more simply, the mass) of the ion, the geometry or size of the electrode structure (for example, the spacing of the electrode structure relative to the center of its internal volume), the magnitude of the AC trapping potential, the frequency of the AC trapping potential, and the magnitude of the DC potential if a DC potential is applied in combination with the AC trapping potential. Through adjustment of the parameters of the trapping voltage (for example, magnitude and frequency), ions of selected mass may be trapped and thereafter ejected. Typically, one or both of the end cap electrodes, and sometimes the ring electrode, have exit apertures through which ejected ions may pass to an ion detection device. One of the end cap electrodes may also have an aperture for admitting ions into the ion trap or an energy beam for forming ions within the ion trap. Depending on design or specific implementation, the top and bottom end cap electrodes may be electrically interconnected, and the ring electrode may be electrically interconnected with one or both of the end cap electrodes.

In addition to three-dimensional ion traps, two-dimensional ion traps are known. For example, linear and curvilinear ion traps have been developed in which the trapping field includes a two-dimensional quadrupolar component that constrains ion motion in the x-y (or r-θ) plane orthogonal to a central linear or curvilinear axis extending through an elongated interior space of the ion trap. As compared with a three-dimensional electrode structure, in a two-dimensional electrode structure the end cap electrodes are replaced with an opposing pair of top and bottom hyperbolically-shaped electrodes that are elongated along the central longitudinal axis. The ring electrode is replaced with an opposing pair of side electrodes similar to the top and bottom electrodes that likewise are elongated in the same axial direction. The result is a set of four axially elongated electrodes arranged in parallel about the central longitudinal axis, and one or both of the opposing pairs of electrodes may be electrically interconnected. Hence, the two-dimensional electrode structure defines an elongated interior space in which ions of a selected mass(es) or mass range(s) may be stably trapped and from which selected ions may be ejected for detection and mass analysis. Similar to the three-dimensional electrode arrangement, the surfaces of the electrodes of the two-dimensional electrode arrangement that face the interior may be shaped as hyperbolas. When viewed in cross-section along a plane orthogonal to the central longitudinal axis, the cross-section of a two-dimensional electrode structure may appear similar to the cross-section of a three-dimensional electrode structure, in that the interior space of either type of electrode structure is generally bounded by hyperbolically-shaped top, bottom, and side electrode surfaces. Variations of linear and curvilinear ion traps include circular and oval “racetrack” configurations.

In the case of a two-dimensional ion trap, ions are confined within an electrodynamic quadrupole field when their trajectories are bounded in both the x and y (or r and θ) directions. The restoring force drives ions toward the central axis of the two-dimensional electrode structure. Because the trapping field is only two-dimensional, DC voltages may be applied to axial end regions of the elongated electrode structure to constrain the motion of ions in the direction of the longitudinal axis and prevent the unwanted escape of ions out from the axial ends of the electrode structure.

Various techniques have been utilized for ejecting ions from three-dimensional and two-dimensional ion traps, usually for the purpose of detecting the ejected ions as part of a mass spectrometry experiment. One popular technique is dipolar resonant ejection, which typically involves applying a supplemental AC field having a frequency and symmetry that is in resonance with one of the frequencies of the motion of a trapped ion (i.e., the secular frequency of the ion). For example, a supplemental AC voltage may be applied to the end cap electrodes of a three-dimensional electrode structure to produce an AC dipole field in the axial direction (for example, the afore-mentioned z-axis). If the frequency of motion of an ion corresponding to the z-axis is equal to the frequency of the supplemental AC voltage, that ion can efficiently absorb energy from the AC dipole field with the result that the amplitude of the axial oscillation of the ion increases. If the AC dipole field is strong enough, the kinetic energy of the ion is increased enough to exceed the restoring force imparted by the trapping field, and the ion is ejected from the trapping field in the axial direction. In this manner, the ion may be directed out of the ion trap for detection by a suitable ion detector, or alternatively be detected by an in-trap ion detector. In addition to supplemental AC dipole fields, supplemental AC quadrupole fields have similarly been employed to resonantly eject ions, as well as a combination of both supplemental dipole and quadrupole fields.

Generally, ion traps can be configured to operate in either a positive ion mode for manipulating positive ions or a negative ion mode for manipulating negative ions. Most commercially available ion traps employ various autotune algorithms to optimize characteristics of performance such as resolution and mass calibration for one type of ion mode only. These algorithms are typically executed in positive ion mode because negative ions are generally more difficult to create, particularly in ion traps coupled to gas chromatography instrumentation. Generally, autotune algorithms executed in negative ion mode are very problematic in ion traps coupled to gas chromatography instrumentation. However, once performance has been optimized in positive ion mode, it would be advantageous to preserve this performance when switching to negative ion mode. Similarly, once performance has been optimized in negative ion mode, it would be advantageous to preserve this performance when switching to positive ion mode. This would mean, among other things, that the force experienced by an ion of a given charge while inside the ion trap should be the same as the force experienced by an ion of opposite charge. Unless a means is provided for preserving performance when switching between positive ion mode and negative ion mode, performance may be degraded. This problem has not been adequately addressed in the prior art.

In view of the foregoing, it would be advantageous to provide a means for preserving the performance of an ion trap, especially resolution and mass calibration, when switching between a positive ion mode of operation and a negative ion mode of operation.

### SUMMARY OF THE INVENTION

To address the foregoing problems, in whole or in part, and/or other problems that may have been observed by persons skilled in the art, the present disclosure provides apparatus, systems, and/or devices and methods for making adjustments or corrections to one or more electric fields applied to an ion trap, as described by way of example in implementations set forth below.

According to one implementation, a method is provided for adjusting a composite electric field to be applied to an ion trap to accommodate switching the operation of the ion trap between a positive ion mode and a negative ion mode. A composite electric field applied to the ion trap is defined as a plurality of component fields including at least one AC trapping field and one or more supplemental AC fields. A phase of one or more of the component fields is adjusted such that a force imparted by the composite field to a negative ion in the ion trap will be substantially the same as the force imparted by the composite field to a positive ion in the ion trap.

According to another implementation, a method is provided for adjusting a composite electric field to be applied to an ion trap to accommodate switching the operation of the ion trap between a positive ion mode and a negative ion mode. A first composite electric field is constructed such that the first composite field is optimized for acting on ions of a first charge type. The first composite electric field comprises a plurality of component fields including at least one AC trapping field and one or more supplemental AC fields. A waveform of at least one of the component fields is reconstructed to create a second composite electric field, whereby a force imparted by the second composite field to ions of a second charge type of opposite sense in the ion trap will be substantially the same as a force imparted by the first composite field to ions of the first charge type.

According to another implementation, an apparatus is provided for trapping ions. The apparatus comprises an ion trap comprising an electrode structure forming an interior space for trapping ions, means for applying a composite electric field to the electrode structure, and means for adjusting the composite field. The composite field comprises a plurality of component fields including at least one AC trapping field and one or more supplemental AC fields. The adjusting means is a means for adjusting the composite field such that a force imparted by the composite field to a negative ion in the ion trap will be substantially the same as the force imparted by the composite field to a positive ion in the ion trap.

### BRIEF DESCRIPTION OF THE DRAWINGS

FIG. 1 is a schematic diagram illustrating a three-dimensional or two-dimensional ion trap in cross-section and associated circuitry in accordance with an example of one implementation.

FIG. 2 is a plot of time-dependent electric field waveforms applied to an ion trap, in which the waveforms are optimized for a positive ion mode of operation.

FIG. 3 is a plot of a time-dependent composite electric field waveform that is desired for a negative ion mode of operation.

FIG. 4 is a plot of time-dependent electric field waveforms that have been phase-adjusted for a negative ion mode of operation.

FIG. 5 is a plot of time-dependent electric field waveforms that have been both phase-adjusted and time-adjusted for a negative ion mode of operation.

FIG. 6 is a flow diagram illustrating a method for adjusting a composite electric field as disclosed herein.

### DETAILED DESCRIPTION OF THE INVENTION

In general, the term “communicate” (for example, a first component “communicates with” or “is in communication with” a second component) is used herein to indicate a structural, functional, mechanical, electrical, optical, magnetic, ionic or fluidic relationship between two or more components or elements. As such, the fact that one component is said to communicate with a second component is not intended to exclude the possibility that additional components may be present between, and/or operatively associated or engaged with, the first and second components.

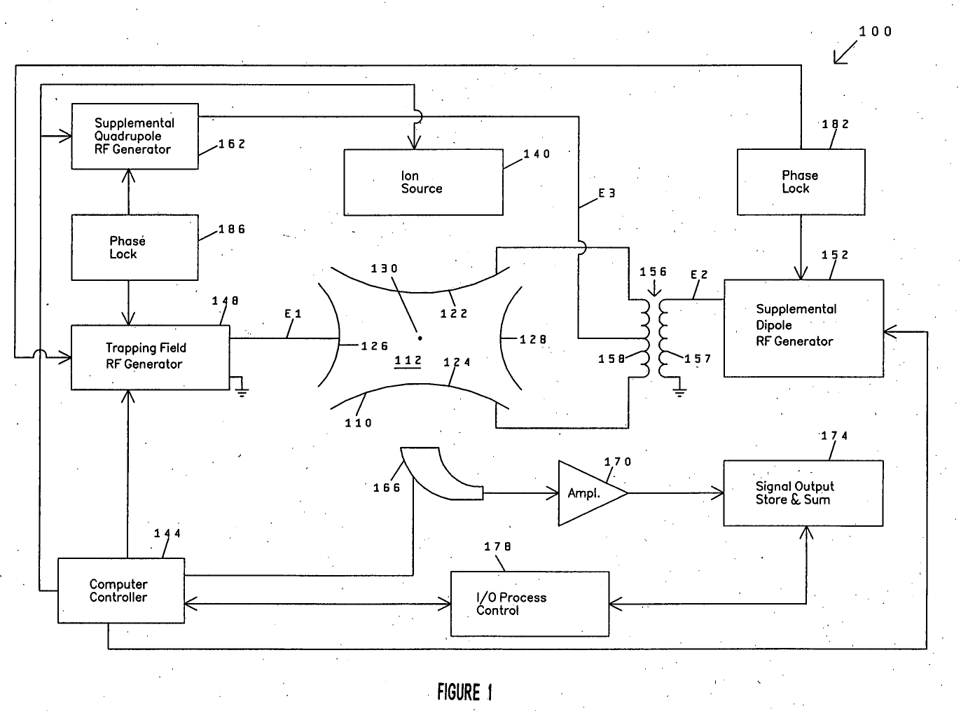

The subject matter disclosed herein generally relates to ion trap apparatus (and/or systems and/or devices) and methods that can be utilized in a wide variety of applications for which control over ion motion is desired. The apparatus and methods are particularly useful for implementing the selection or sorting of either positive or negative ions according to their respective m/z ratios. Thus, the apparatus and methods are particularly useful in mass spectrometry although are not limited to this type of operation. Examples of implementations of apparatus and methods are described in more detail below with reference to FIGS. 1-5.

FIG. 1 illustrates an example of a mass spectrometry (MS) apparatus or system 100 of the type that may be used in performing the methods disclosed herein. The MS apparatus 100 may include an electrode structure defining an ion trap 110 and associated circuitry. In FIG. 1, the cross-section of an ion trap 110 is defined by four hyperbolically-shaped, electrically conductive surfaces arranged such that two opposing pairs of surfaces face inwardly toward each other, thereby defining a central interior space 112 of the ion trap 110 suitable for containing an ion trapping volume or region. From the perspective of FIG. 1, the ion trap 110 comprises an opposing pair of electrodes including a top electrode 122 and a bottom electrode 124, and an opposing pair including two side electrodes 126 and 128. However, the configuration of the ion trap 110 depicted in FIG. 1 may be either three-dimensional or two-dimensional. That is, in one implementation, the top electrode 122 may be an upper end cap electrode, the bottom electrode 124 may be a lower end cap electrode, and the side electrodes 126 and 128 may be part of a continuous ring electrode instead of being physically separate electrodes. The geometric center of the interior space 112 of the ion trap 110 is indicated at point 130.

In other implementations, the top electrode 122 may be an elongated upper electrode, the bottom electrode 124 may be an elongated lower electrode, and the side electrodes 126 and 128 may be elongated side electrodes. The elongation occurs in a direction along a central longitudinal axis of two-dimensional ion trap. From the perspective of FIG. 1, the central longitudinal axis is directed into the drawing sheet and is represented by the point 130. The interior space 112 of this type of ion trap 110 is thus also elongated along the longitudinal axis 130.

For present purposes, to account for the applicability of either three-dimensional or two-dimensional geometry, the ion trap 110 illustrated in FIG. 1 is characterized as including a top electrode 122 (an upper end cap electrode or elongated upper electrode), a bottom electrode 124 (a lower end cap electrode or elongated lower electrode), and side electrodes 126 and 128 (a ring electrode or two opposing elongated side electrodes). For convenience, the ion trap 110 illustrated in FIG. 1 will be described herein primarily in the context of a three-dimensional configuration (ring and end cap arrangement) with the understanding that a two-dimensional (for example, linear four-rod) configuration is applicable as well.

In the case of a three-dimensional configuration, the opposing pair of top and bottom electrodes 122 and 124 (upper end cap electrode and lower end cap electrode) may be electrically interconnected by any suitable means, depending on the desired implementation. In the case of a two-dimensional configuration, the opposing upper electrode 122 and lower electrode 124 may be electrically interconnected by any suitable means and the opposing side electrodes 126 and 128 may be electrically interconnected by any suitable means, again depending on the desired implementation.

As used herein, the term “hyperbolic” and like terms are intended to encompass substantially hyperbolic profiles. That is, the shapes of the electrodes 122, 124, 126 and 128—or at least their surfaces that inwardly face the interior space 112 of the ion trap 110—may or may not precisely conform to the known mathematical parametric expressions that describe perfect or ideal hyperbolas or hyperboloids. For example, the electrodes 122, 124, 126 and 128 or their inwardly facing surfaces may have circular profiles instead of hyperbolic profiles. In the case of a two-dimensional ion trap, in addition to hyperbolic sheets or plates, the electrodes 122, 124, 126 and 128 may be structured as cylindrical rods as in many quadrupole mass filters, or as flat plates. In all such cases, the electrodes 122, 124, 126 and 128 may nonetheless be employed to establish an effective quadrupolar trapping electric field in a manner suitable for many implementations.

Ion trap apparatus 110 may include an ionization device 140 for providing or introducing sample ions in the interior space 112 of the ion trap 110. In the present context, the terms “providing” or “introducing” are intended to encompass the use of either a suitable internal ionization technique or a suitable external ionization technique. Generally, internal ionization encompasses first using a sample inlet system (not shown) to introduce sample material into the ion trap 110 and then ionizing the introduced sample material, while external 110 ionization encompasses first ionizing sample material and then introducing the ionized species into the ion trap 110. Accordingly, in some implementations, gaseous or aerosolized sample material may be injected into the ion trap 110, such as through a gap between two adjacent electrodes, either directly or as the output of another type of analytical instrument (not specifically shown) such as a gas chromatographic (GC), liquid chromatographic (GC), electrophoretic, electrochromatographic, or like instrument. In these implementations, the ionization device 140 may represent a device for directing a beam of energy into the ion trap 110, such as through an aperture in one of the electrodes (for example, the top electrode 122), suitable for ionizing the sample material in the ion trap 110. The energy beam may be, for example, an electron beam, laser beam, or the like. Any suitable ionization technique may be employed, a few examples being chemical ionization (CI) and electron impact ionization (EI). When chemical ionization is performed, a source of reagent gas (not specifically shown) may be employed for introducing a reagent gas into the ion trap 110. In other implementations, the ionization device 140 may represent an ionization interface or ion source that receives sample material either directly or as the output of another type of analytical instrument (for example, GC or LC), ionizes the sample material in accordance with any suitable ionization technique, and then directs the resulting ion stream into the ion trap 110. Examples of ion sources typically employed for external ionization include, but are not limited to, atmospheric pressure chemical ionization (APCI), atmospheric pressure photo-ionization (APPI), and electrospray ionization (ESI) devices. For simplicity, components such as, for example, lenses, gates, mirrors, multipole electrode structures, and the like that may be needed for guiding energy or ions from the ionization device 140 to the ion trap 110 are not specifically shown, as such technology is well known to persons skilled in the art. It will be further appreciated by persons skilled in the art that the MS apparatus 100 may be designed to enable more than one type of ionization technique to be selected.

Whether configured for internal ionization or external ionization, the operation of the ionization device 140, as well as any gas and sample material sources, may be controlled by any suitable electronic control device or system (or electronic controller 144), as shown in FIG. 1. For example, the gating of an energy beam, the flow of sample material, or the flow of externally created ions may be synchronized with other operations of the MS apparatus 100 such as the application of electric fields to the ion trap 110. The MS apparatus 100 may also include one or more sources (not shown) of inert background gases that direct such gases into the ion trap 110 for various purposes such as damping the oscillations of trapped ions, effecting collisionally induced dissociation (CID) of ions, and the like. The operation of these additional gas sources may likewise be controlled by the electronic controller 144.

As a general matter, the electronic controller 144 in FIG. 1 is a simplified schematic representation of an electronic or computing operational system for the MS apparatus 100. As such, the electronic controller 144 may include, or be part of, a computer, microcomputer, microprocessor, microcontroller, analog circuitry, or the like as those terms are understood in the art. In addition to data acquisition, manipulation, storage and output, the electronic controller 144 may implement any number of other functions such as computerized control of one or more components of the MS apparatus 100. The electronic controller 144 may represent or be embodied in more than one processing component. For instance, the electronic controller 144 may comprise a main controlling component such as a computer in combination with one or more other processing components that implement more specific functions (for example, data acquisition, data manipulation, transmission of information or interfacing tasks between components, et cetera). The electronic controller 144 may implement various aspects of instrumental control such as temperature, various voltages (DC and/or RF) applied to the ion trap 110, ion optics voltages, electric field strength, scanning parameters, waveform parameters and synthesis, frequency mixing, clocking and timing, phase locking, et cetera. The electronic controller 144 may have both hardware and software attributes. In particular, the electronic controller 144 may be adapted to execute instructions embodied in computer-readable or signal-bearing media for implementing one or more of the algorithms, methods or processes described below, or portions or subroutines of such algorithms, methods or processes. The instructions may be written in any suitable code, one example being C. The electronic controller 144 may include input interfaces for receiving commands and data from a user of the MS apparatus 100, and output interfaces for communicating with readout/display means (not shown).

The MS apparatus 100 may include one or more voltage sources as necessary to produce a main or fundamental electric trapping field for confining ions of a selected range or ranges of m/z values to stable trajectories within the ion trap 110, as well as to produce one or more supplemental electric fields for such purposes as ejecting ions of selected m/z values via resonant excitation. In the example given by FIG. 1, the MS apparatus 100 includes a main RF waveform generator 148 that is electrically connected to the ring electrode 126, 128 of a three-dimensional ion trap 110 to produce a potential difference between the ring electrode 126, 128 and the top and bottom end cap electrodes 122 and 124, or to the elongated side electrodes 126 and 128 and top and bottom electrodes 122 and 124 of a two-dimensional ion trap 110 to produce a potential difference between the side electrodes 126 and 128 and the top and bottom electrodes 122 and 124 at one or more points along the longitudinal axis 130. The voltage signal applied by the main RF waveform generator 148 may be characterized as generally having the basic form V₁ sin (ω₁t+φ₁), and produces a quadrupolar trapping field within the ion trap 110. In FIG. 1, the main RF waveform is indicated by E₁ on the signal line between the main RF waveform generator 148 and the ring or side electrode 126. Whether the main trapping field is able to stably trap any ion present within the ion trap 110 generally depends on the m/z value of that ion, the amplitude V₁ and frequency ω₁ of the waveform, and the physical dimensions of the ion trap 110. The electronic controller 144 may be connected to the main RF waveform generator 148 to control the amplitude V₁ and frequency ω₁ of the fundamental RF voltage. The main RF waveform is typically created from a master clock associated with the electronic controller 144. While in some implementations the main RF waveform is fixed by an oscillator, in other implementations the main RF waveform is created by a digital-to-analog converter (DAC) under the control of the electronic controller 144. In some implementations, the main RF waveform generator 148 is a broadband multi-frequency waveform generator. In some implementations, a DC voltage source (not shown) may also be employed to apply a DC voltage component of magnitude U to the trapping field as is known to persons skilled in the art. If a DC voltage source is employed, then the ability to trap the ion may also depend on the magnitude U.

The MS apparatus 100 may include one or more voltage sources as necessary to effect axial resonance ejection of trapped ions on a sequential, mass-selective basis. In the example given by FIG. 1, the MS apparatus 100 may include a supplemental, arbitrary RF waveform generator 152 that is electrically connected to the top and bottom end cap electrodes 122 and 124 of a three-dimensional ion trap 110, or to the elongated top and bottom electrodes 122 and 124 of a two-dimensional ion trap 110, to produce a potential difference between this opposing pair of electrodes 122 and 124. In some implementations, the supplemental RF waveform generator 152 is a broadband multi-frequency waveform generator. In the present example, the supplemental RF waveform generator 152 is coupled to the ion trap 110 through a transformer 156. In one implementation, the supplemental RF waveform generator 152 may be coupled to both terminals of the primary winding or coil 157 of the transformer 156 and the center tap of the secondary winding or coil 158 may be grounded. In another implementation, as shown in FIG. 1, one of the terminals of the primary coil 157 may be connected to ground and the center tap of the secondary coil 158 connected to an additional supplemental RF generator 162 as described below. The voltage signal applied by the supplemental RF waveform generator 152 may be characterized as generally having the basic form V₂ sin (ω₂t+φ₂), and produces a dipolar excitation field within the ion trap 110 between the opposing top and bottom electrodes 122 and 124. In FIG. 1, the supplemental RF waveform is indicated by E₂ on the signal line between the supplemental RF waveform generator 152 and the transformer 156. The electronic controller 144 may be connected to the supplemental RF waveform generator 152 to control the amplitude V₂ and frequency ω₂ of the supplemental RF voltage. The arbitrary waveform clock may be derived from the master clock associated with the electronic controller 144. As appreciated by persons skilled in the art, the arbitrary waveform(s) may be created, for instance, by utilizing electronic controller 144 to execute a software program that computes the waveform parameters and creates a data file whose contents are loaded into random-access memory (RAM) and then clocked out into a digital-to-analog converter (DAC). The software may be employed to compute the waveform parameters so as to optimize the performance of the ion trap 110 for a given MS experiment and for operation in either positive ion mode or negative ion mode. Typically, optimization is done for positive ion mode. The software may be transferred to or loaded into the electronic controller 144 by any suitable, known wired or wireless means. For purposes of the present disclosure, the software may be considered as residing within the electronic controller 144 schematically depicted in FIG. 1.

Each trapped ion has a distinctive secular frequency of oscillatory motion along a given axis or direction that depends on the m/z ratio of the ion as well as the physical dimensions of the ion trap 110 (which are typically fixed) and the trapping parameters (amplitude V₁ and frequency ω₁) of the main trapping field. If the secular frequency of any trapped ion matches the frequency ω₂ of the supplemental RF waveform, a resonance condition exists that allows energy from the dipolar excitation field to be coupled with the periodic motion of the ion along the relevant component direction. If the dipolar excitation field is strong enough, the oscillation of the ion along the relevant component direction will increase in amplitude to a point at which the ion is able to escape the confines of the trapping region within the ion trap 110. Therefore, by implementing a scanning operation, trapped ions of successive m/z ratios can be resonantly ejected from the ion trap 110. For instance, the main trapping field may be held constant so that the respective secular frequencies of trapped ions of differing m/z ratios are likewise held constant, and ejection is effected by varying the frequency ω₂ of the supplemental RF waveform. In this manner, ions of successive m/z ratios are brought into resonance with the frequency ω₂ and thereby successively ejected from the ion trap 110. Alternatively, the dipolar excitation field may be held constant while a parameter (amplitude V₁ or frequency ω₁) of the main trapping field is varied, thereby changing the respective secular frequencies of trapped ions of differing m/z ratios. In this manner, ions of successive m/z ratios are brought into resonance with the fixed frequency ω₂ and thereby successively ejected from the ion trap 110 as their respective secular frequencies match up with the frequency ω₂ of the supplemental RF waveform. When a mass scan is performed by resonant ion ejection, it is usually preferable to scan the amplitude V₁ of the voltage of the quadrupole trapping component to change the respective secular frequencies of the trapped ion, because in such case it is easier to maintain a desired relationship between the frequency ω₁ of the trapping voltage and the frequency ω₂ of the excitation voltage.

As an example of operating the MS apparatus 100, ions of differing m/z values are provided or introduced in the ion trap 110 by performing an internal or external ionization technique as described above. A quadrupolar trapping field is applied to the ion trap 110 to trap all ions or ions of a selected range or ranges of m/z values. If necessary or desired, a suitable damping gas may be introduced in the ion trap 110 to thermalize the ions so as to cause their orbits to collapse or settle into a smaller volume at or near the center of the ion trap 110, which may improve mass resolution. After storing the ions for a period of time, the ions are then sequentially ejected from the ion trap 110 according to their successive m/z ratios by means of a suitable ejection technique, such as resonance ejection through the use of a dipolar excitation field and a selected scanning strategy as described above. The ejected ions travel along an intended direction (for example, the axis of the applied excitation field dipole) and pass through one or more apertures (not shown) of one or more electrodes of the ion trap 110 (for example, the bottom electrode 124 shown in FIG. 1). The ejected ions are collected by a suitable ion detector 166. Generally, the ion detector 166 may be any device capable of converting an ion beam received as an output from the ion trap 110 into an electrical signal. In the example illustrated in FIG. 1, the ion detector 166 is externally positioned relative to the ion trap 110. Examples of external ion detectors include, but are not limited to, those utilizing electron multipliers, photomultipliers, or Faraday cups. Preferably, the polarity of the ion detector 166 can be switched according to whether positive or negative ionization is being implemented. Ions from the ion trap 110 may be focused toward the ion detector 166 by means of an applied electrical field and/or electrode structures that serve as ion optics (not specifically shown). The electrical and structural ion optics are preferably designed so as to separate the ion beam from any neutral particles and electromagnetic radiation that may also be discharged from the ion trap 110, thereby reducing background noise and increasing the signal-to-noise (S/N) ratio. In other implementations, the ion detector 166 may be internally positioned relative to the ion trap 110. That is, an ion detector of known design could be incorporated into the electrode structure of the ion trap 110 or disposed within the interior space 112 of the ion trap 110. In-trap ion detection may also be implemented by one or more of the trap electrodes 122, 124, 126 and 128 themselves, by detecting image currents induced in the electrodes 122, 124, 126 and 128 from ion excursions.

Once the ion detector 166 has performed ion-to-electron conversion, the output signals generated by the ion detector 166 may be processed by any suitable means as needed to yield a mass spectrum that is interpretable by a trained analyst to obtain information regarding the sample material processed by the MS apparatus 100. In the example illustrated in FIG. 1, the output from the ion detector 166 may be amplified by an amplifier 170, and the output from the amplifier 170 may be stored and processed by signal output store and sum circuitry 174. Data from the signal output store and sum circuitry 174 may be, in turn, processed by an input/output (I/O) process control card 178. The output from the I/O process control card 178 may be further processed by the electronic controller 144. The mass spectrum may be displayed or printed by a suitable readout/display means (not shown). Generally, components and techniques for acquiring and processing data, conditioning signals, and displaying spectral information are well known to persons skilled in the art and thus need not be described in further detail. Moreover, it is readily appreciated by persons skilled in the art that one or more of these components may be controlled by the electronic controller 144.

In addition to producing a dipolar excitation field, additional supplemental RF waveforms may be provided for other purposes. For example, the ion trap 110 and associated circuitry illustrated in FIG. 1 may be configured to implement, if desired, an asymmetrical trapping field in combination with one or more supplemental excitation fields. Generally, an asymmetrical trapping field is one in which the center of the trapping field is displaced from the geometric center 130 of the ion trap 110. Details of the theory and practice of asymmetrical trapping fields are known and described, for example, in U.S. Pat. Nos. 5,291,017 and 5,714,755, which are commonly assigned to the assignee of the present disclosure. Briefly, the asymmetrical trapping field may be constructed from a combination of quadrupole and dipole components having the same frequency. The quadrupole component of the trapping field corresponds to the afore-described main RF trapping field. The dipole component of the trapping field may be created passively, such as by using unequal lumped-parameter impedances that in a schematic representation would be shown interconnected between the transformer 156 and the top and bottom electrodes 122 and 124. Alternatively, a supplemental dipole voltage generator, such as the generator 152 shown in FIG. 1, may be employed to actively create the trapping field dipole. Alternatively, the trapping field dipole may be created by both passive and active means. In all such cases, the trapping field dipole typically does not itself contribute to the ejection of ions by resonant excitation as its frequency will not match any of the secular frequencies of the trapped ions. In practice, it may be desirable to first apply a symmetrical trapping field to the ion trap 110 during the ion formation stage in the case of internal ionization, or during the ion injection stage in the case of external ionization, to allow the ions to settle into stable periodic motions concentrated at the structural center 130 of the ion trap 110. Thereafter, the trapping field may be rendered asymmetrical by application of the dipole trapping field component.

As described in detail in above-referenced U.S. Pat. No. 5,714,755, when employing an asymmetrical trapping field it may be useful to employ a supplemental quadrupolar excitation field. This alternative is represented in FIG. 1, which indicates that the MS apparatus 100 may include a supplemental quadrupole RF voltage generator 162 communicating with the center tap of the secondary coil 158 of the transformer 156. Accordingly, the quadrupole excitation field may be created by applying the signal from the supplemental quadrupole RF voltage generator 162 to the center tap of the secondary coil 158 of the transformer 156. In this manner, the quadrupole component of the excitation field is applied by the top and bottom electrodes 122 and 124 of the ion trap 110 while the quadrupole component of the trapping field is applied by the ring electrode 126, 128 or side electrodes 126 and 128. This is commonly done since the trapping field is generally provided by a tuned resonant circuit that does not allow for easy communication of the quadrupole excitation field frequencies. The voltage signal applied by the supplemental quadrupole RF waveform generator 162 may be characterized as generally having the basic form V₃ sin (ω₃t+φ₃). The frequency ω₃ of the supplemental quadrupole RF voltage preferably differs from the frequency ω₁ of the quadrupole trapping voltage. In FIG. 1, the supplemental quadrupole RF waveform is indicated by E₃ on the signal line between the supplemental quadrupole RF generator 162 and the center tap of the secondary coil 158 of the transformer 156. The electronic controller 144 may be connected to the supplemental quadrupole RF waveform generator 162 to control the amplitude V₃ and frequency ω₃ of the supplemental quadrupole RF voltage. The supplemental quadrupole waveform is typically “weak” in the sense that it is not strong enough to independently trap a measurable number of ions. Although it is quadrupolar and generally centered at the structural center 130 of the ion trap 110, the supplemental quadrupole waveform is able to act on trapped ions because the center of the supplemental quadrupolar excitation field does not coincide with the center of the asymmetrical trapping field. That is, the strength of supplemental quadrupolar excitation field is non-zero at the center of the asymmetrical trapping field. In some implementations, the supplemental quadrupole RF waveform generator 162 is a broadband multi-frequency waveform generator.

As in the case of the above-described supplemental dipole excitation waveform, the supplemental quadrupole excitation waveform may be created from a software program executed in the electronic controller 144. The software program may create a data file whose contents are loaded into random-access memory (RAM) and then clocked out into a digital-to-analog converter (DAC). Moreover, the software may be employed to compute the waveform parameters of the supplemental quadrupole RF voltage so as to optimize the waveform for a given MS experiment and for operation in either positive ion mode or negative ion mode. Typically, this optimization is done for positive ion mode.

In another implementation involving the use of an asymmetrical trapping field, the supplemental excitation voltage includes not only the quadrupole excitation component just described, but also a dipole excitation component that often has the same frequency as the quadrupole excitation component. The supplemental dipole excitation component of the excitation field may be created passively or actively in the same manner as the afore-described dipole component employed to create the asymmetrical trapping field. For example, the supplemental dipole excitation component may be created by the active supplemental dipole RF waveform generator 152. The supplemental dipole field may be weak such that it would not, acting alone, be capable of ejecting ions from the ion trap 110. Mass resolution may be enhanced by employing both quadrupole and dipole excitation field components, which allows all excitation field components to be minimized.

In another implementation, the excitation field may include both dipole and quadrupole components, but is applied without employing an asymmetrical trapping field. For example, a symmetrical trapping field may be employed to trap ions and then the dipole and quadrupole excitation field components are applied such that the trapped ions absorb power from their respective resonances sequentially. The dipole component is applied to resonantly excite ions on a mass-selective basis. As these ions absorb power from the dipole resonance, the amplitudes of their oscillations along the intended axial direction are increased. In this manner, the ions can be moved out of the central null field of the mass-selective resonant quadrupole field component and thus can absorb enough power from the quadrupole component to be ejected from the ion trap 110.

In some implementations, it may be desirable to lock the respective phases of the trapping field voltages and the excitation field voltages to eliminate the effects of frequency beating or for other purposes. A significant beat frequency may cause mass peaks to be so distorted that it may be difficult to correct for, particularly when sample material is provided in the form of a continuous flow from a GC system. Accordingly, as illustrated in FIG. 1, suitable phase-locking circuitry 182 may be interposed between the main RF waveform generator 148 and the supplemental dipole RF waveform generator 152, and additional phase-locking circuitry 186 may be interposed between the main RF waveform generator 148 and the supplemental quadrupole RF waveform generator 162.

In the operation of the MS apparatus 100 such as described above and illustrated in FIG. 1, the ion trap 110 (its waveform parameters, etc.) may be optimized for functioning in either positive ion mode or negative ion mode, and the MS apparatus 100 may have the ability to switch between the positive ion mode and the negative ion mode. It is generally easier to optimize an ion trap 110 for positive ion mode as compared to negative ion mode. However, the fact that the ion trap 110 is optimized, for instance, in positive ion mode does not guarantee that the performance-related benefits gained from such optimization will be retained after switching to negative ion mode. For example, when supplemental waveforms are employed in a manner that renders the phases of the supplemental waveforms relative to the fundamental trapping waveform important, such as for resonant ion ejection, mass resolution and calibration may be degraded during operation in negative ion mode after optimization in positive ion mode since the direction of ion motion due to the applied electric fields will be reversed in all three dimensions (x, y, and z).

Therefore, in accordance with one implementation, the present disclosure provides a means for adjusting the electric field of an ion trap 110 (for example, the ion trap 110 illustrated in FIG. 1) when operated in one ion mode after the ion trap 110 has been tuned for optimal operation in the other ion mode. As described in the examples given above, the electric field may be a composite or combined field that includes one or more trapping field components and one or more supplemental field components. One or more components of the composite electric field may be adjusted such that the force experienced by an ion of a given sense (positive or negative) with a given amount of charge is identical or substantially identical to the force experienced by an ion of opposite sense containing the same amount of charge, neglecting second order effects such as dipole moment, collisional cross-section, et cetera. For example, the electric field may be adjusted when the ion trap 110 is operated in the negative ion mode after the ion trap 110 has been tuned in the positive ion mode, such that the force experienced by a negative ion is identical or substantially identical to the force experienced by a positive ion of equal charge.

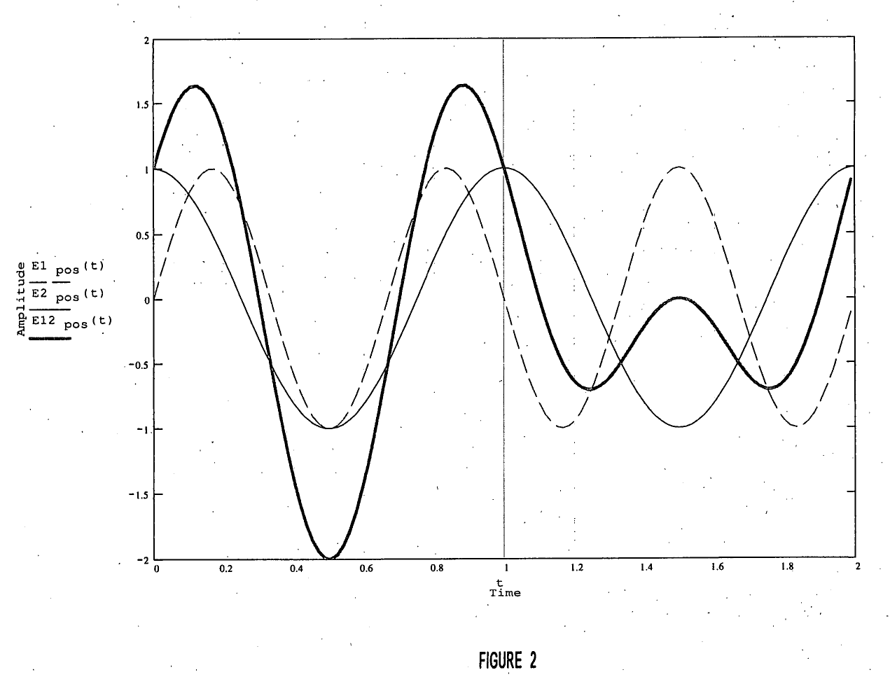

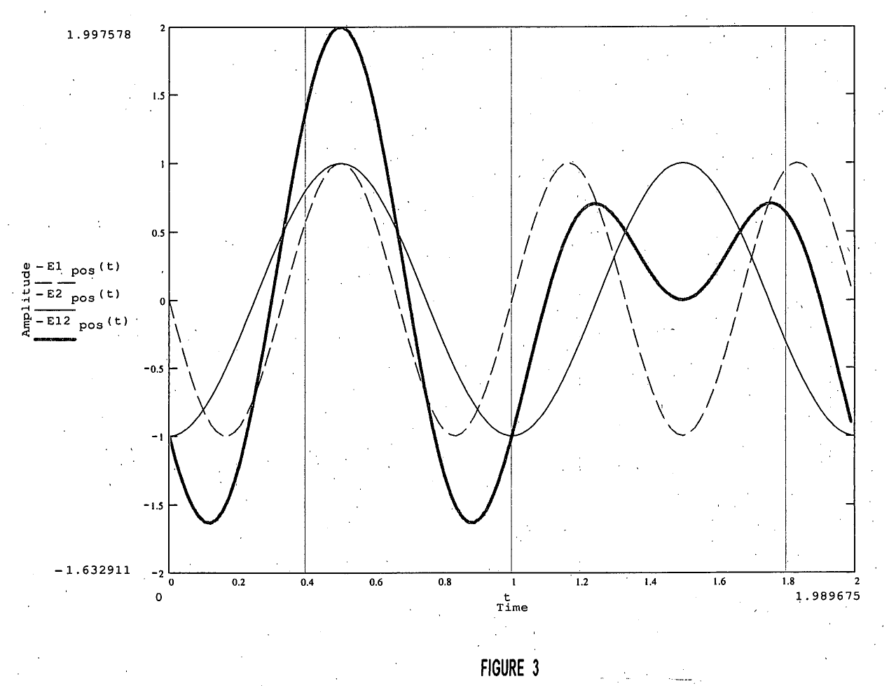

An example of the technique disclosed herein may be described by first considering that the force on an ion due to an electric field E is F=qE, where F and E are vectors and q is the charge on the ion. Let E be the sum of two periodic, time-dependent functions E₁(t) and E₂(t). By way of example, and to reflect a typical implementation, let the periodic functions E₁(t) and E₂(t) be sinusoids such that E₁(t)=sin(ωt) and E₂(t)=A sin(ωtm/n+φ), where ω is the frequency of the sinusoid, m and n are any two real numbers, A is the ratio of the amplitudes of E₁(t) and E₂(t), and φ is a phase value. Assume that the force Fₚₒₛ on a positive ion of charge qₚₒₛ has been optimized by some method, yielding a set of two sinusoids E₁ₚₒₛ(t)=sin(ωt) and E₂ₚₒₛ(t)=A sin(ωtm/n+φₚₒₛ) For example, FIG. 2 illustrates plots of E₁ₚₒₛ and E₂ₚₒₛ in a case where ω=3π radians, φ=π/2 radians, A=1, m=2, and n=3. The sum of E₁ₚₒₛ and E₂ₚₒₛ, or E₁₂ₚₒₛ, is shown in the bold trace. If a negative ion is now to be analyzed and the same electric fields E₁ₚₒₛ and E₂ₚₒₛ are to be applied, the force on the negative ion will be in the opposite sense as the force on the positive ion. It is desirable to have the force on the negative ion be of the same sense as the force on the positive ion. In other words, it is desirable to have F_{neg}(t)=Fₚₒₛ(t) or, equivalently, E_{1neg}(t)+E_{2neg}(t)=−(E₁ₚₒₛ(t)+E₂ₚₒₛ(t)), as shown in FIG. 3. This goal will be achieved if E_{1neg}(t)=−E₁ₚₒₛ(t) and if E_{2neg}(t)=−E₂ₚₒₛ(t).

Assume further that a time shift Δt is allowable, as is a phase shift from φₚₒₛ to φ_{neg}.

Thus, it is desired that:
sin(ω(t+Δt))=−sin(ωt) and (1)
sin(ω(t+Δt)m/n+φ_{neg})=−sin(ωtm/n+φₚₒₛ). (2)

Equation (1) is satisfied if Δt=(2k+1)π/ω, where k is any integer. By way of example, for k=0, Δt=π/ω, and the first equation is now:
sin(ωt+π)=−sin(ωt) (1a)
The second equation now becomes, for k=0:
sin(ωtm/n+πm/n+φ_{neg})=−sin(ωtm/n+φₚₒₛ), or: (2a)
sin(ωt+π)m/n+φ_{neg})=−sin(ωtm/n+φₚₒₛ). (2b)

The equation above will be satisfied if the arguments of the two sine functions differ by (2k+1)π:
((ωt+π)m/n+φ_{neg})=(ωtm/n+φₚₒₛ)+(2k+1)π. (2b)

Rearrangement Yields:
Δφ=φ_{neg}−φₚₒₛ=π((2k+1)n−m)/n
For k=0, Δφ=π(n−m)/n.

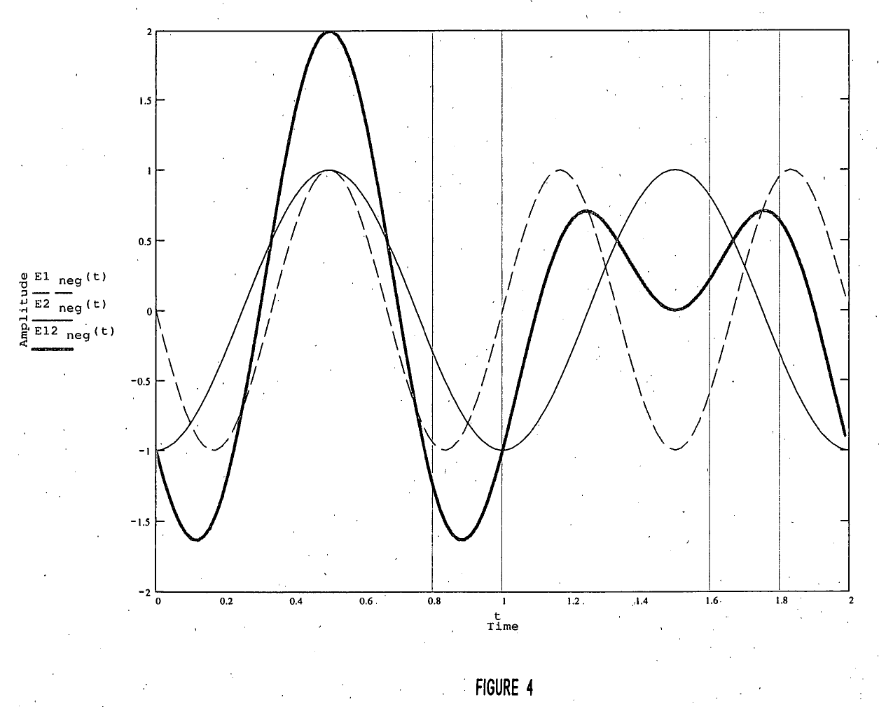

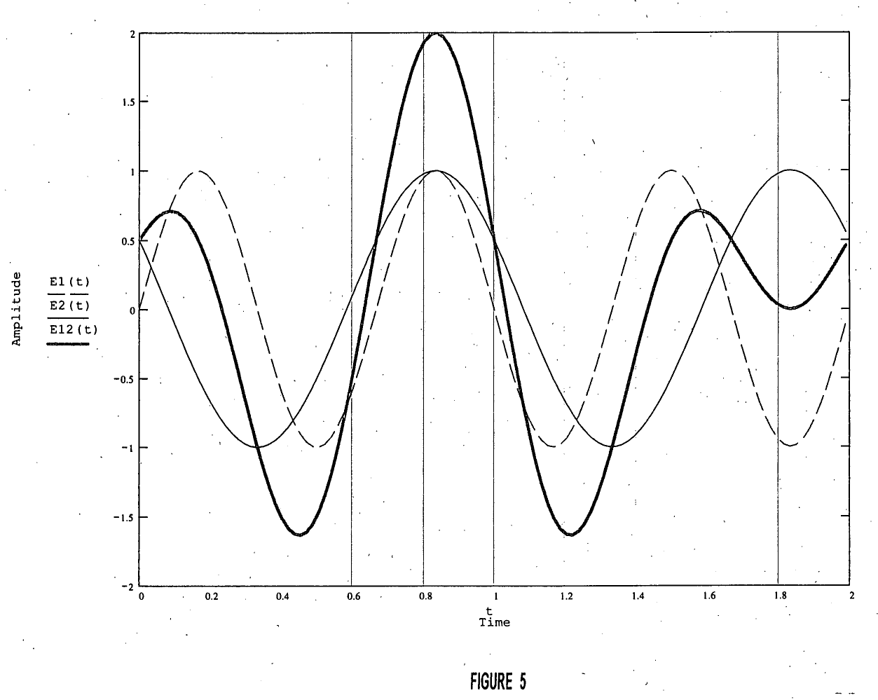

The end result is that if E₂ₚₒₛ is phase shifted by π(n−m)/n radians and if both E₁ₚₒₛ and E₂ₚₒₛ are time shifted by π/ω seconds, then the force on the negative ion is identical to that experienced by a positive ion in response to the original E₁ₚₒₛ and E₂ₚₒₛ waveforms, as shown in FIG. 4. It will be noted that in the present example, m=2 and n=3 and hence the phase shift in FIG. 4 is π(3−2)/3, or π/3. The adjusted phase in the argument of the sine function for E₂ for negative ion mode is thus φ_{neg}=φₚₒₛ+π/3, or φ_{neg}=π/2+π/3. If the time shift Δt is removed, the result is shown in FIG. 5, in which the total field E₁₂ (that is, E₁+E₂) is identical to the desired total field for negative ions E_{12neg} shown in FIGS. 3 and 4 except for a delay. It will be noted that in the present example, ω=3π and hence the time shift is Δt=π/ω=π/3π, or ⅓ radian. It can be seen that the phase shift by itself causes a delay in the total field E₁₂ relative to the desired field E_{12neg}. Introduction of the time shift cancels out the delay. In practice, this delay is generally not significant as it represents one half cycle of the trapping RF field. The resulting time shift, assuming a typical trapping RF frequency of 1 MHz, is 0.5 μsec. If a typical mass scanning rate of 100 μsec/amu (or Dalton) is used, the resulting mass shift is 0.005 amu. It should be noted that this mass shift is the only adverse effect of the delay; mass resolution, for example, is unaffected by the delay. As will be described below, one preferred implementation of the present disclosure invention does not include the time shift because of the additional hardware that would often be required.

As previously discussed, the composite or combined electrical field applied to an ion trap 110 at a given stage of operation may include more than one supplemental or auxiliary periodic field, i.e., a plurality of fields Eᵢ. As with E₂ in the above example, the relative phases of one or more of these additional fields Eᵢ may be important such that their adjustment is desired when switching between positive ion mode and negative ion mode. The process just described may be repeated for these additional fields Eᵢ. In view of the foregoing disclosure, the process is straightforward as it simply involves equating E_{ineg}(t) to −Eᵢₚₒₛ(t) as was done for E₂(t). Depending on the purpose of the various supplemental fields E₂, E₃, E₄, . . . , Eᵢ to be adjusted (for example, resonance ion ejection), these fields after adjustment may be applied to the ion trap 110 simultaneously during a given stage of operation. In addition, these fields may be applied to the same electrode as the sum of sinusoids or they may be applied to different electrodes.

The improvement in the performance of an ion trap 110 when switching between the positive ion mode of operation and negative ion mode is evident from a comparison of the waveforms illustrated in FIGS. 2, 4 and 5. Assume again that the waveform E₁(t)=sin(ωt) is employed for the main trapping field and the waveform E₂(t)=K sin(ωtm/n+φ) is employed for a supplemental purpose such as axial modulation, and further that the waveform parameters (for example, ω, m, n, and φ) have been optimized for positive ion mode. If the ion trap 110 is then switched to negative ion mode without making adjustments to either waveform E₁(t) or E₂(t), the result may be, in one example, a mass shift on the order of approximately 0.3 amu. Additionally, mass resolution and other aspects of performance may be adversely affected. If, on the other hand, a phase shift of π(n−m)/n is introduced in the waveform E₂(t) for negative ion mode such that E_{2neg}(t)=sin((ωt+π)m/n+φ_{neg})=sin((ωtm/n+φₚₒₛ+π(n−m)/n)) as shown in FIG. 5, the mass shift is essentially eliminated. It will be noted that in practical applications such as the present example, the result may be a mass shift on the order of approximately 0.01 amu, but a mass shift on this order is relatively insignificant for most applications. That is, the adjustment of phase without inclusion of the time shift (FIG. 5) is not considered to adversely affect mass calibration in most applications. In other words, adjustment to the supplemental waveform as shown in FIG. 5 is sufficient in most applications. If, further, the time shift is included by introducing the time delay Δt in the waveforms E₁(t) and E₂(t) such that E_{1neg}(t)=sin(ω(t+Δt)) and E_{2neg}(t)=sin((mω(t+Δt)/n+φₚₒₛ+π(n−m)/n)) as shown in FIG. 4, the result in this example would be a further improvement of approximately 0.01 amu. Because the mass shift is a constant, it may be compensated for without the need for any tuning algorithm. Thus, the introduction of both a phase shift and time shift as in FIG. 4 may be considered an ideal case that may be implemented but may not be necessary in every application.

It can be seen that the foregoing technique can be applied to the operation of an ion trap that is employed in MS applications, where the waveform E₁ corresponds to the main RF waveform utilized to produce the trapping field and the waveforms E₂, E₃, E₄, . . . , Eᵢ correspond to supplemental waveforms utilized to produce other fields for such purposes as resonance ejection. According to one implementation, in the course of operating an MS apparatus with an ion trap (for example, the MS apparatus 100 and ion trap 110 described above and illustrated in FIG. 1), optimal values for one or more supplemental waveforms Eᵢ are determined for positive ions. In the case of FIG. 1, the supplemental waveforms Eᵢ to be adjusted may include the dipole RF waveform E₂ and the quadrupole RF waveform E₃. As discussed previously in the context of the MS apparatus 100 illustrated in FIG. 1, the optimized parameters may be computed by software so that the output from an arbitrary waveform generator is dictated by a computer data file. The use of software and data files facilitates the making adjustments to the waveforms Eᵢ for the purpose of switching to negative ion mode, because adjustments such as phase shifting can be effected by creating an appropriate replacement data file. That is, the waveforms E_{ineg} for negative ions may be created by recomputing the waveforms Eᵢₚₒₛ previously constructed for positive ions with the phase shift of π(n−m)/n added to the phase of each waveform Eᵢₚₒₛ to be adjusted and, if desired, the time shift of Δt added. The new waveforms E_{ineg} could also be created by starting the original waveforms Eᵢₚₒₛ at a different point in RAM. For example, suppose a positive-ion waveform Eᵢ₊ occupies 360 positions in RAM, and the generation starts at memory location 0. In the example where m=2 and n=3, for a phase shift of 60 degrees (or −300 degrees), the corresponding negative-ion waveform E_{ineg} could be generated by starting waveform generation at memory location 60. It will be noted that after memory location 359 is sent to the DAC, the waveform wraps around to memory location 0 and continues. It will also be noted that since this technique represents a time shift, it is only effective for waveforms containing one sinusoidal component where a time shift can be uniquely related to a phase shift.

As an alternative, the phase of the waveform E₁ of the main RF generator may be shifted in addition to changing the phase of the supplemental waveform(s) Eᵢ. In many implementations, however, this alternative is less preferred. As previously noted, the supplemental waveforms Eᵢ are often generated in software and subsequently created by a DAC. Thus, a supplemental waveform in such cases can be shifted simply by manipulating the data created by the DAC. On the other hand, the RF phase of the waveform that produces the main trapping field is often fixed by an oscillator, in which case shifting this phase would involve additional hardware. However, in cases where the RF phase is created by a DAC, for example, changing this RF phase would be convenient. In this alternative, the phase shift of the trapping field and supplemental waveform(s) is effected by an inversion, or 180-degree phase shift, of each individual waveform as can be seen from FIG. 3.

As another alternative, the phase(s) of the supplemental waveform(s) Eᵢ may be shifted using a hardware-based technique, either with or without shifting the phase of the waveform E₁ of the main RF generator. Again, this may be less preferred than the afore-described software-based techniques because those techniques do not require additional hardware.

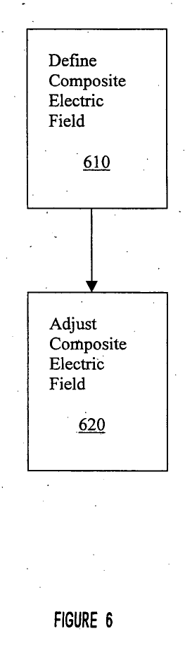

FIG. 6 illustrates an example of one implementation of a method for adjusting a composite electric field to be applied to an ion trap to accommodate switching the operation of the ion trap between a positive ion mode and a negative ion mode. At block 610, a composite electric field applied to the ion trap is defined as a plurality of component fields. The component fields may include at least one AC trapping field and one or more supplemental AC fields. At block 620, one or more of the component fields are adjusted such that a force imparted by the composite field to a negative ion in the ion trap will be substantially the same as the force imparted by the composite field to a positive ion in the ion trap. Preferably, the adjustment is made to a phase of one or more of the component fields. The method may be employed to construct a first composite electric field as just described, and which is optimized for acting on ions of a first charge type (positive or negative). The adjustment may comprise reconstructing a waveform of at least one of the component fields to create a second composite electric field, such that a force imparted by the second composite field to ions of a second charge type of opposite sense (negative or positive) in the ion trap will be substantially the same as the force imparted by the first composite field to ions of the first charge type (positive or negative).

It will be understood that the apparatus and methods disclosed herein can be implemented in an MS system as generally described above and illustrated in FIG. 1 by way of example. The present subject matter, however, is not limited to the specific MS apparatus 100 illustrated in FIG. 1 or to the specific arrangement of circuitry illustrated in FIG. 1. Moreover, the present subject matter is not limited to MS-based applications.

It will be noted that, in practice, some ion traps produce higher-order multi-pole field components, such as hexapole and octopole field components. In some cases, the higher-order fields are deliberate or at least desirable because they can be utilized to obtain advantages such as improved mass resolution and resonant ejection of ions. Higher-order fields may result from non-ideal physical characteristics of the electrode structure, such as by stretching the separation between opposing electrodes or shaping the surfaces of the electrodes to deviate from perfect hyperbolic profiles. Higher-order fields may also result from the application of certain types of electric field components, such as certain trapping field dipoles. The inventive principles disclosed herein may be applied to ion traps that include higher-order field components, whether produced by physically inherent or electrical means.

As previously noted, the subject matter disclosed and claimed herein may also find application to ion traps that operate based on ion cyclotron resonance (ICR), which employ a magnetic field to trap ions and an electric field to eject ions from the trap (or ion cyclotron cell). Apparatus and methods for implementing ICR techniques are well-known to persons skilled in the art and therefore need not be described in any further detail herein.

It will also be understood that the apparatus and methods disclosed herein may be applied in conjunction with tandem MS (MS/MS) applications and multiple-MS (MSⁿ) applications. For instance, ions of a desired m/z range can be trapped and subjected to CID by well known means using a suitable background gas (for example, helium) for colliding with the “parent” ions. Parent ions of selected m/z ratios can be isolated in the ion trap by ejecting other, unwanted ions by means of a suitable ejection technique such as mass-selective instability ejection, resonant ejection, or the like. The resulting fragment or “daughter” ions can then be mass analyzed, and the process can be repeated for successive generations of ions. Generally, MS/MS and MSⁿ applications are well-known to persons skilled in the art and therefore need not be described in any further detail herein.

It will also be understood that the periodic voltages applied in the implementations disclosed herein are not limited to sinusoidal waveforms. As a general matter, the principles taught herein may be applied to other types of periodic waveforms such as triangular (saw tooth) waves, square waves, and the like.

It will be further understood that various aspects or details of the invention may be changed without departing from the scope of the invention. Furthermore, the foregoing description is for the purpose of illustration only, and not for the purpose of limitation—the invention being defined by the claims.

What is claimed is:

1. A method for adjusting a composite electric field to be applied to an ion trap to accommodate switching the operation of the ion trap between a positive ion mode and a negative ion mode, comprising the steps of:
defining a composite electric field applied to the ion trap as a plurality of component fields including at least one AC trapping field and one or more supplemental AC fields; and
adjusting a phase of one or more of the component fields such that a force imparted by the composite field to a negative ion in the ion trap will be substantially the same as the force imparted by the composite field to a positive ion in the ion trap.

2. The method of claim 1, wherein adjusting comprises adjusting a phase of at least one of the supplemental fields.

3. The method of claim 2, wherein the at least one supplemental field is a dipolar excitation field or a quadrupolar excitation field.

4. The method of claim 1, wherein the one or more supplemental fields comprise a plurality of excitation fields, and adjusting comprises adjusting respective phases of all of the excitation fields.

5. The method of claim 1, wherein adjusting comprises adjusting a phase of the trapping field.

6. The method of claim 1, wherein adjusting comprises adjusting a phase of the trapping field and a phase of at least one of the supplemental fields.

7. The method of claim 1, wherein adjusting comprises reconfiguring hardware employed to apply the one or more adjusted component fields to the ion trap.

8. The method of claim 1, wherein adjusting comprises recomputing data in software employed to apply the one or more adjusted component fields to the ion trap.

9. The method of claim 1, wherein at least one of the supplemental fields is an excitation field, and the method further comprises applying the excitation field to the ion trap as a component of the adjusted composite field to eject trapped ions of one or more different masses from the ion trap by resonance ejection.

10. The method of claim 1, wherein at least one of the component fields to be adjusted is defined at least in part by a waveform that includes a periodic function given by sin(ωtm/n+φ) where ω is the frequency of the waveform, t is time, m and n are any two real numbers, and (p is the phase angle of the waveform, and adjusting comprises subtracting a value given by ±π((2k+1)n−m)/n where k is any integer.

11. The method of claim 1, wherein the component fields of the composite field are defined at least in part by respective periodic waveforms, and adjusting further comprises removing a time shift from the periodic waveforms.

12. A method for adjusting a composite electric field to be applied to an ion trap to accommodate switching the operation of the ion trap between a positive ion mode and a negative ion mode, comprising the steps of:
constructing a first composite electric field such that the first composite field is optimized for acting on ions of a first charge type, the first composite electric field comprising a plurality of component fields including at least one AC trapping field and one or more supplemental AC fields; and
reconstructing a waveform of at least one of the component fields to create a second composite electric field, whereby a force imparted by the second composite field to ions of a second charge type of opposite sense in the ion trap will be substantially the same as a force imparted by the first composite field to ions of the first charge type.

13. The method of claim 12, wherein, prior to adjusting, the ion trap is set to a first operating mode for acting on ions of the first charge type and the first composite field is optimized for application to the ion trap during the first operating mode, and the method further comprises:
switching the ion trap to a second operating mode for acting on ions of the second charge type; and
applying the second composite field to the ion trap during the second operating mode.

14. The method of claim 13, wherein the first operating mode is a positive ion mode and ions of the first charge type are positive ions, and the second operating mode is a negative ion mode and ions of the second charge type are negative ions.

15. The method of claim 14, wherein the first operating mode is a negative ion mode and ions of the first charge type are negative ions, and the second operating mode is a positive ion mode and ions of the second charge type are positive ions.

16. An ion trap apparatus comprising:
an ion trap comprising an electrode structure forming an interior space, which traps ions;
means for applying a composite electric field to the electrode structure, the composite field comprising a plurality of component fields including at least one AC trapping field and one or more supplemental AC fields; and
means for adjusting the composite field such that a force imparted by the composite field to a negative ion in the ion trap will be substantially the same as the force imparted by the composite field to a positive ion in the ion trap.

17. The ion trap apparatus of claim 16, wherein the adjusting means comprises means for adjusting a phase of one or more of the component fields.

18. The ion trap apparatus of claim 17, wherein the one or more component fields to be adjusted are defined at least in part by respective periodic waveforms, and the adjusting means further comprises means for adjusting a time at which at least one of the waveforms is applied to the ion trap.

19. The ion trap apparatus of claim 16, wherein the adjusting means comprises circuitry employed to create one or more periodic waveforms of the composite field.

20. The ion trap apparatus of claim 16, wherein the adjusting means comprises software employed to create one or more periodic waveforms of the composite field.
